(19) United States
(12) Patent Application Publication
(10) Pub. No.: US 2019/0282929 A1
(43) Pub. Date: Sep. 19, 2019

(54) ELECTRIC HEATER TREATER

(71) Applicant: REDHEAD SERVICES, L.L.C., ODESSA, TX (US)

(72) Inventors: JAROD LANE SHELTON, MIDLAND, TX (US); RYAN JAY FAULKENBERRY, MIDLAND, TX (US); BRANDON LEE RODGERS, BIG SPRING, TX (US)

(21) Appl. No.: 15/921,264

(22) Filed: Mar. 14, 2018

(51) Int. Cl. B01D 17/04; H05B 1/02; B01D 17/02; C02F 1/02

(52) U.S. Cl. CPC B01D 17/042; H05B 1/0244; C02F 2101/32; C02F 1/02; B01D 17/0214

(57) ABSTRACT

A heater treater and methods for retrofitting and operating a heater treater are provided. The heater treater comprises a housing, at least one heat exchanger tube, at least one electric heater, and a sufficient volume of a heat transfer fluid. The housing has one or more fluid inlet and outlet ports. The heat exchanger tube is positioned at least partially within the housing. The electric heater comprises an electric heating element. The electric heating element is positioned within the heat exchanger tube. A sufficient volume of the heat transfer fluid is within the heat exchanger tube.

### FIELD

The present disclosure generally relates to heater treaters used in the oil and gas industry, and more specifically, to heater treaters used to break emulsions.

### BACKGROUND

Heater treaters separate oil and water by breaking the oil-water emulsion through the application of heat. Typical heater treaters are equipped with and utilize a fire tube to apply such heat. At the inlet of the fire tube, a burner shoots flames through the fire tube to heat up the oil within the heater treater. Heating the oil in this way has its deficiencies. First, using a fire tube and burner configuration introduces an open flame in a processing plant around flammable gases and products, which can result in fires and/or explosions. This can result in costly downtime of the production plant and/or injury to workers in the vicinity of the fire tube. Secondly, hot spots within the fire tube develop and eventually cause the fire tube to crack or develop a hole. This requires repair or replacement of the fire tube before the heater treater can be put back into operation. Lastly, the use of the burner with an open flame produces unwanted emissions into the environment. Therefore, there is a need for an apparatus that effectively breaks oil-water emulsions through the application of heat without the use of an open flame.

### SUMMARY

In accordance with the present disclosure, an apparatus, a method of using the apparatus, and a method of retrofitting a fire tube heater treater into an electrically-heated heater treater are provided.

In one embodiment, a heater treater is provided. The heater treater comprises a housing, at least one heat exchanger tube, at least one electric heater, and a sufficient volume of a heat transfer fluid. The housing has one or more fluid inlet and outlet ports. The heat exchanger tube is positioned at least partially within the housing so as to be in contact with an emulsion flowing through the housing. The electric heater comprises an electric heating element. The electric heating element is positioned within the heat exchanger tube. A sufficient volume of the heat transfer fluid is within the heat exchanger tube such that the electric heating element is in contact with the heat transfer fluid. In some embodiments, the heat transfer fluid may be glycol.

In addition to or in the alternative to the previous embodiment, the heater treater can further comprise an electrical power source and a temperature controller. The electrical power source is in communication with the electric heater. The temperature controller is in communication with the electric heater and the electrical power source. The temperature controller may include a temperature probe that is in contact with an emulsion within the housing. The temperature controller regulates electrical current from the electrical power source to the electric heater to increase or decrease the heat output of the electric heating element.

In another embodiment, there is provided a method of using a heater treater to heat emulsions. In the method, an emulsion is flowed through a housing. The emulsion is heated with at least one electric heater having an electric heating element positioned within at least one heat exchanger tube. The at least one heat exchanger tube is at least partially within the housing so as to be in contact with the emulsion. In some embodiments, the heat exchanger tube is filled with heat transfer fluid.

In another embodiment, there is provided a method of retrofitting a heater treater having a housing, at least one heat exchanger tube, and a burner in communication with the at least one heat exchanger tube. The method comprises first removing the burner from communication with the heat exchanger tube. Next, an electric heater is positioned within the at least one heat exchanger tube. During the method, the at least one heat exchanger tube is filled with a sufficient volume of a heat transfer fluid such that the electric heating element is in contact with the heat transfer fluid. Afterwards, the heat exchanger tube is sealed, thereby retaining the heat transfer fluid within the heat exchanger tube.

In some embodiments, the previous method can further comprise the steps of: removing an upper portion of an exhaust stack; and sealing the remaining portion of the exhaust stack with a flange, wherein the flange is equipped with a pressure relief valve and a fill neck. The fill neck allows for filling the heat exchanger tube with the heat transfer fluid. In additional embodiments, the previous method can further comprise the step of: providing a temperature controller in communication with the electric heater and in contact with an emulsion in the housing. The temperature controller can be capable of managing the flow of electricity from an electrical power source to the electric heater. Also, the temperature controller can regulate electrical current from the electrical power source to the electric heater to increase or decrease the heat output of the electric heating element.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a side view of a heater treater in accordance with one embodiment of the present disclosure.

FIG. 2 is a cross-sectional view of the heater treater in FIG. 1.

FIG. 3 is a front view of an end cap for a heat exchanger tube.

FIG. 4 is a cross-sectional view of a heater treater having two heat exchanger tubes.

FIG. 5 is a cross-sectional view of a heater treater in accordance with an embodiment of this disclosure.

FIG. 6 is a cross-sectional view of a heater treater using a burner and flame as the heating element before being retrofitted in accordance with this disclosure.

FIG. 7 is a cross-sectional view of the heater treater of FIG. 6 during the retrofit process in accordance with this disclosure.

FIG. 8 is a cross-sectional view of the heater treater of FIG. 6 after the retrofit process in accordance with this disclosure.

### DETAILED DESCRIPTION

The present disclosure may be understood more readily by reference to these detailed descriptions. For simplicity and clarity of illustration, where appropriate, reference numerals may be repeated among the different figures to indicate corresponding or analogous elements. In addition, numerous specific details are set forth in order to provide a thorough understanding of the various embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

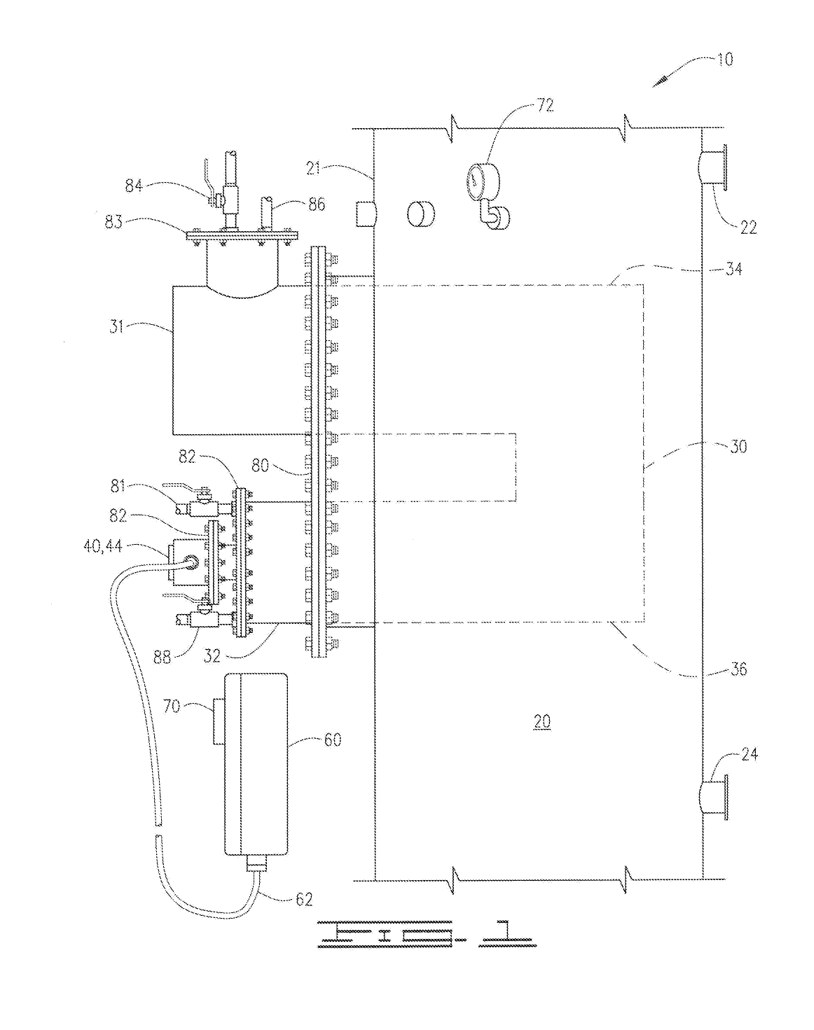

Referring now to FIGS. 1-3 generally, the heater treater of the current disclosure is illustrated and generally designated by the numeral 10. As shown by the drawings, the general form of heater treater 10 includes housing 20, heat exchanger tube 30, electric heater 40, and heat transfer fluid 50. Housing 20 has an inlet port 22 and an outlet port 24. Inlet port 22 allows emulsions to flow into housing 20 and outlet port 24 allows the emulsion components, such as hydrocarbons and water, to flow out of housing 20. In some embodiments, housing 20 may include two or more outlet ports 24 such that hydrocarbons, gas emissions, and water may flow to different holding tanks or to different areas of the processing plant. For example, one outlet port 24 may be a lower outlet port for the separated water, and some hydrocarbons, to flow out of housing 20 and the other outlet port 24 may be an upper outlet port for the separated hydrocarbons, and some water, to flow out of housing 20.

Heat exchanger tube 30 is a hollow tube with a bore extending from a first end 31 to a second end 32. The bore is suitable for containing an electric heating element and a heat transfer fluid, as further described below. Heat exchanger tube 30 is positioned at least partially within housing 20 such that heat exchanger tube 30 is in contact with an emulsion 90 flowing through housing 20. Heat exchanger tube 30 being at least partially within housing 20 allows for heat from within heat exchanger tube 30 to transfer through the walls of heat exchanger tube 30 to emulsions 90 within housing 20.

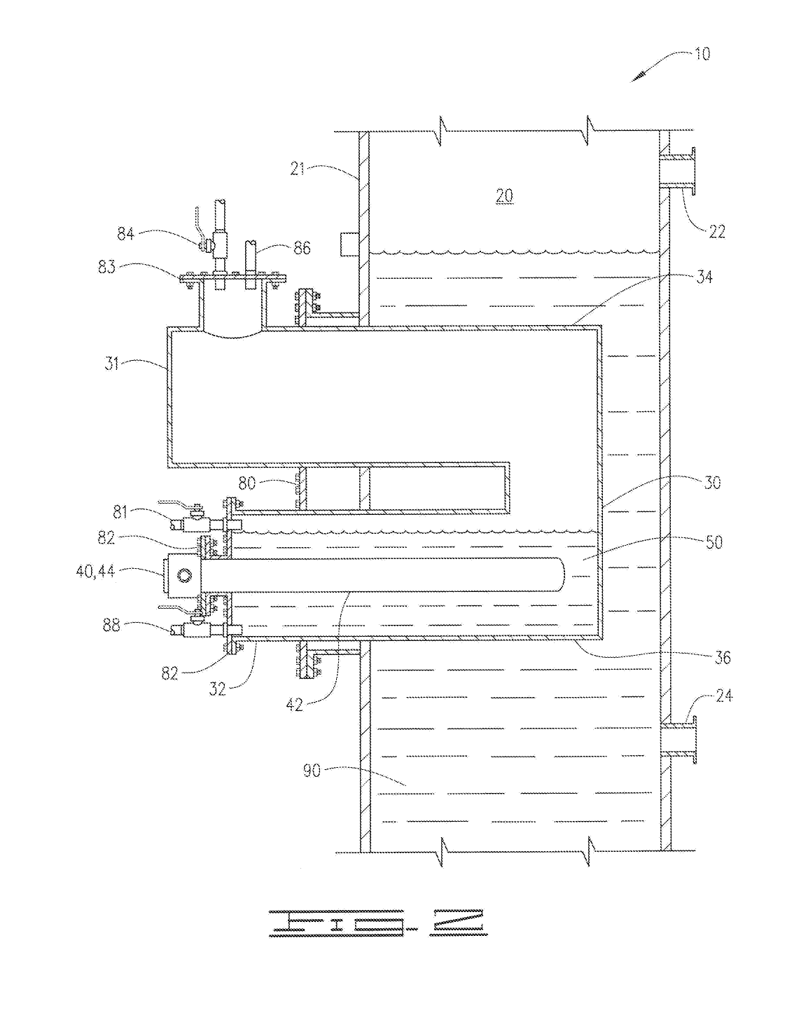

Heat exchanger tube 30 may take various forms. For example, as illustrated in FIG. 2, heat exchanger tube 30 may be a U-shaped tube having legs 34 and 36. First end 31 and second end 32 terminate at the outer surface 21 of housing 20 with U-shaped tube 30 extending into the interior of housing 20. Generally, to create a closed system, the ends 31, 32 are sealed with end cap 80 to retain heat transfer fluid 50 within heat exchanger tube 30. In other embodiments, heat exchanger tube 30 may have ends 31 and 32 that extend past the surface of housing 20, but typically will still be adjacent to outer surface 21.

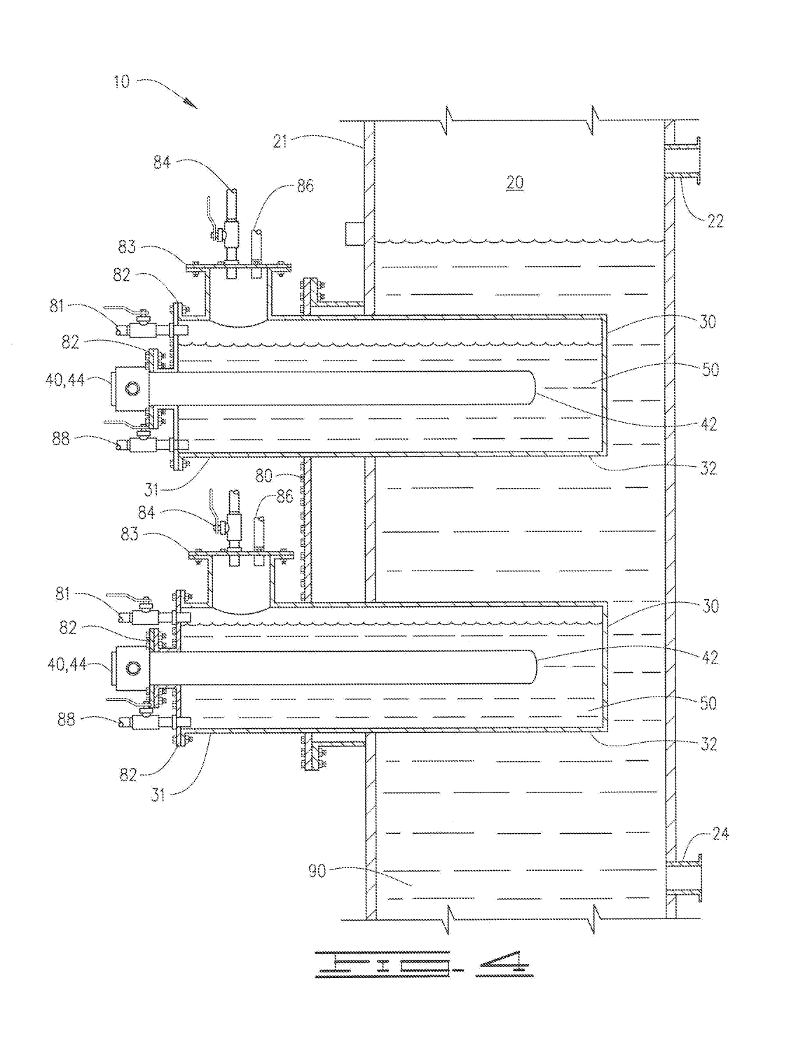

In an alternative embodiment, as illustrated in FIG. 4, heater treater 10 may comprise two or more heat exchanger tubes 30. For example, in some embodiments including two heat exchanger tubes 30, heat exchanger tubes 30 may be parallel to one another having first ends 31 that terminate at the outer surface 21 of housing 20 and second ends 32 that extend straight into the interior of housing 20. In such embodiments, heat exchanger tubes 30 may each be equipped with an electric heater 40 having an electric heating element 42 that extends into heat exchanger tube 30.

In some embodiments, heat transfer fluid 50 may continuously flow into and out of heat exchanger tube 30. In other embodiments, heat exchanger tube 30 may be a closed system. In closed system embodiments, heat transfer fluid 50 is sealed within heat exchanger tube 30 rather than being flowed into and out of heat exchanger tube 30.

Electric heater 40 in its most general form consists of an electric heating element 42 and a control unit 44. Suitable examples of electric heater 40 include immersion type heaters, screw type heaters, and flange type heaters. For example, manufacturers of suitable heaters include Glow-Quartz, Durex Industries, Big Chief, Wattco, and Vulcan Electric. Electric heater 40 is attached to housing 20 through one or more flanges 82 being connected to end cap 80. Typically, electric heater 40 is attached such that control unit 44 is located outside housing 20 and such that electric heating element 42 is positioned at least partially within heat exchanger tube 30. In some embodiments, utilizing single tube heat exchanger tubes, as depicted in FIG. 4, electric heating element 42 may extend from first end 31 to second end 32 of heat exchanger tube 30; however, generally electric heating element 42 will extend only about 90% of the length of tube 30, and more typically about 75% or less than the length of heat exchanger tube 30. For a U-shaped tube 30, electric heating element 42 will generally only extend through one of the legs 34, 36 of the U-shaped tube and thus can have a length of 50% or less of the length of heat exchanger tube 30. Thus, for example, as shown in FIG. 2, electric heating element 42 may only extend the length of leg 36 of the U-shaped heat exchanger tube 30. Optionally, the electric heating element 42 may only extend about 80% to about 99%, or about 80% to about 90% of the length of leg 36. In some embodiments having a U-shaped heat exchanger tube 30, heat exchanger tube 30 may include more than one electric heater 40. For example, both legs 34, 36 of the U-shaped heat exchanger tube 30 may be equipped with an electric heater 40 with an electric heating element 42 extending into each leg 34, 36. If heater treater 10 includes more than one heat exchanger tube 30, for example, as illustrated in FIG. 4, each one of heat exchanger tube 30 may include an electric heater 40.

A sufficient volume of heat transfer fluid 50 is within heat exchanger tube 30 such that electric heating element 42 is in contact with heat transfer fluid 50. Generally, the amount of heat transfer fluid 50 in heat exchanger tube 30 should be sufficient to completely immerse electrical heating element 42; however, it is within the scope of the invention for electrical heating element 42 to be less than totally immersed. Heat transfer fluid 50 may be comprised of glycol. For example, heat transfer fluid 50 may be triethylene glycol having a boiling point of 545° F. Heat transfer fluid 50 may be introduced into heat exchanger tube 30 through fill neck 86. Once a sufficient volume of heat transfer fluid 50 is within heat exchanger tube 30, fill neck 86 may be closed off. One of ordinary skill in the art will readily understand that fill neck 86 may be closed in various ways such as by closing a valve or capping fill neck 86. When there is a need to empty heat transfer fluid 50 from heat exchanger tube 30, heat transfer fluid 50 may be removed from heat exchanger tube 30 using drain 88. For example, it may be desirous to remove heat transfer fluid 50 through drain 88 when maintenance on heat exchanger tube 30 is required. Additionally, there should be sufficient heat transfer fluid 50 in tube 30 to adequately contact the inner surface of heat exchanger tube 30 to effect heat transfer to the emulsion 90 flowing within housing 20. Typically, this requires there be sufficient heat transfer fluid 50 to contact at least 40% of the inner surface of tube 30; however, more typically there will be sufficient heat transfer fluid 50 to be in contact with at least 50% of the inner surface of heat exchanger tube 30. In some embodiments, there will be sufficient heat transfer fluid 50 to be in contact with at least 60%, 70% or even 80% of the inner surface of heat exchanger tube 30. In some embodiments, heat exchanger tube 30 will be 100% filled with heat transfer fluid 50.

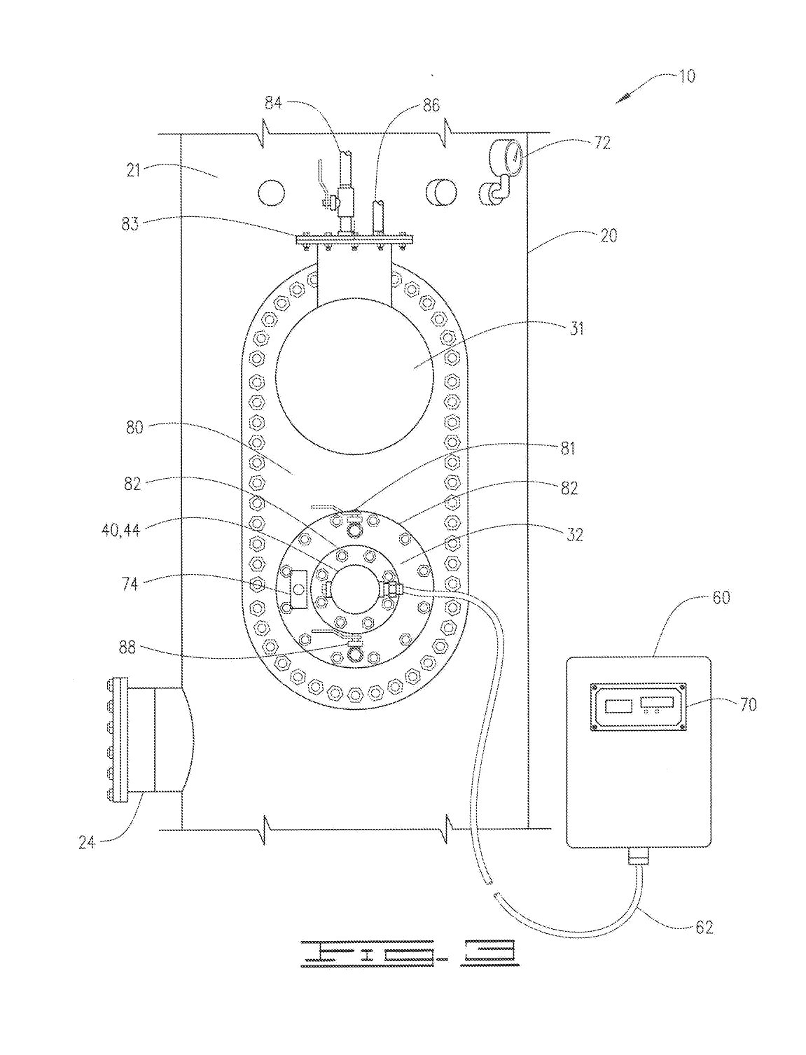

Referring now to FIG. 3, in some embodiments, heater treater 10 may further include a power source 60 and a temperature controller 70. Power source 60 is in communication with electric heater 40 through control unit 44 via probe line 62. Temperature controller 70 is in communication with power source 60. Temperature controller 70 is in communication with electric heater 40 through control unit 44 via probe line 62. Temperature controller 70 may include a temperature probe 72 that is in contact with emulsion 90 within housing 20 so as to detect the temperature of emulsion 90 within housing 20. Generally, temperature probe 72 will extend into the interior of housing 20 so as to be in contact with emulsion 90. Temperature probe 72 may be in communication with temperature controller 70 via a probe line. In some embodiments, temperature probe 72 may be in communication with temperature controller 70 via wireless communication. In other embodiments, temperature probe 72 may be a stand alone thermometer that must be manually read. Temperature controller 70, in conjunction with control unit 44, regulates electrical current from power source 60 to electric heating element 42 such that the heat output of electrical heating element 42 can be increased or decreased. In some embodiments, a second temperature probe 74 may be positioned within heat exchanger tube 30 such that the temperature of heat transfer fluid 50 may be measured and monitored.

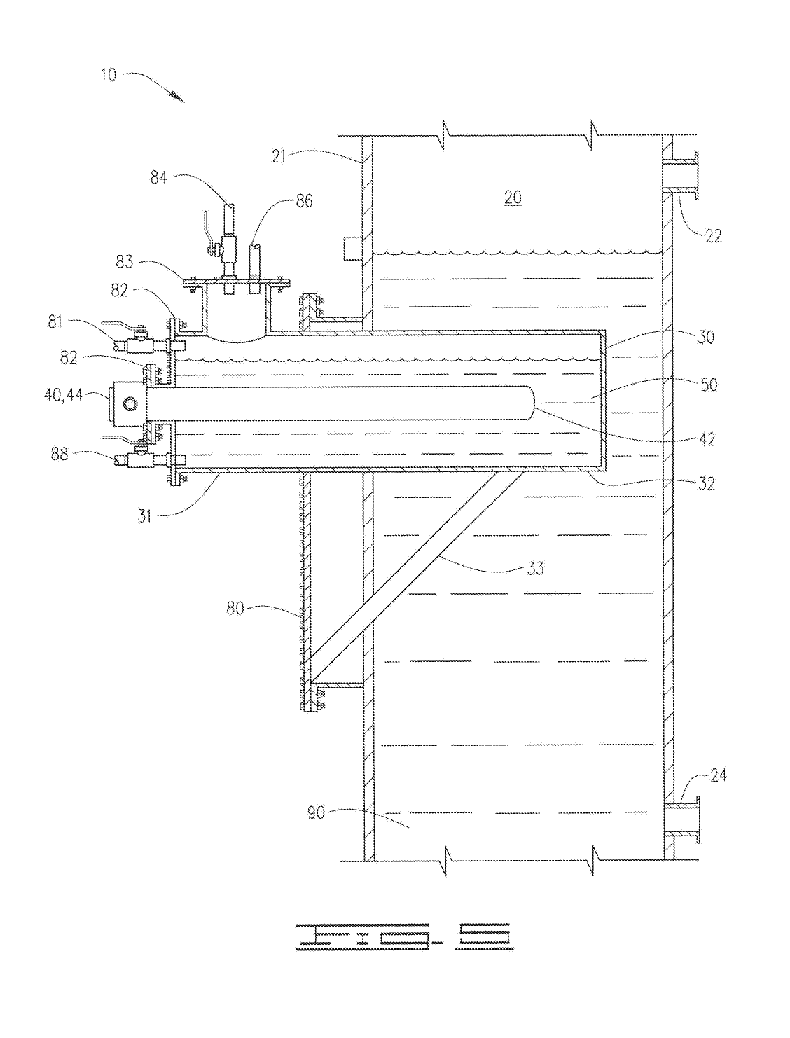

Referring now to FIG. 5, in some embodiments, heater treater 10 may further include brace 33. Brace 33 may be positioned such that additional support is given to heat exchanger tube 30 within housing 20. In embodiments including one or more heat exchanger tubes 30, multiple braces 33 may be used to provide additional support within housing 20 to heat exchanger tubes 30. One of ordinary skill in the art will readily understand that various configurations of the size and shape of brace 33 may be used and various materials may used to construct brace 33.

In operation, a heater treater according to this disclosure can heat oil-water emulsions to be at a temperature in excess of 140° F., which is more than adequate for breaking such oil-water emulsions. More typically, the hydrocarbons of the present heat treater can be heated to a temperature in the range of from 110° F. to 140° F. for emulsion breaking. If temperature probe 72 measures that the hydrocarbons are above or below the desired temperature, temperature controller 70 communicates with electric heater 40 through control unit 44 to increase or decrease the heat output from electric heating element 42.

Referencing now specifically FIG. 3, in some embodiments, heat exchanger tube 30 is sealed with end cap 80. In its most general form, end cap 80 includes an opening for electric heater 40 to pass through into heat exchanger tube 30. Electric heater 40 is connected to end cap 80 with one or more flanges 82. In some embodiments, end cap 80 may include a check valve 81 that can be opened to determine if heat transfer fluid 50 has reached a certain level in heat exchanger tube 30. In other embodiments, end cap 80 may include pressure relief valve 84 and fill neck 86. Pressure relief valve 84 is a safety feature such that pressure can be relieved from within heat exchanger tube 30. Fill neck 86 allows for heat transfer fluid 50 to be introduced into heat exchanger tube 30 initially, and also allows for heat exchanger tube 30 to be filled with additional amounts of heat transfer fluid 50 if it is desired that electric heating element 42 be fully immersed within heat transfer fluid 50. In some embodiments, pressure relief valve 84 and fill neck 86 may be connected to end cap 80 via flange 83. In other embodiments, end cap 80 includes drain 88 such that heat transfer fluid 50 may be removed from heat exchanger tube 30 through drain 88. For example, it may be desired to remove heat transfer fluid 50 from heat exchanger tube 30 through drain 88 to allow for maintenance on heat exchanger tube 30 or if a new type of heat transfer fluid 50 is desired to be utilized.

Returning now to FIGS. 1-3 generally, the operation of heater treater 10 to heat emulsions 90 will now be described. In operation, an emulsion 90 is introduced into housing 20 through inlet port 22. Emulsion 90 will generally be one formed from hydrocarbons and water. More typically, the emulsion will be formed from oil and water.

Emulsion 90 introduced into housing 20 flows generally from inlet port 22 to outlet port 24 and thus flows downward through housing 20. As emulsion 90 flows downward through housing 20, it contacts heat exchanger tube 30. While the emulsion is flowing through housing 20, electric heating element 42 is operated so as to heat the heat transfer fluid 50 contained within heat exchanger tube 30. Heat transfer fluid 50 is in contact with both electric heating element 42 and the inner surface of heat exchanger tube 30 so that the heat from electric heating element 42 is transferred to heat exchanger tube 30 and subsequently is transferred to downward flowing emulsion 90 in housing 20.

In some embodiments where multiple heat transfer tubes 30 are used, the tubes 30 will be arranged so that one set of tubes 30 is higher in housing 20 than another set of tubes 30. In such embodiments, the higher or upper tubes 30 can be at the same or a lower temperature than the lower tubes 30, so that the downward flowing emulsion 90 is gradually heated to the emulsion breaking temperature as it passes through housing 20.

The heat provided to emulsion 90 is sufficient to break the hydrocarbon and water emulsion into its hydrocarbon component and water component. These components continue flowing downward through housing 20 and can be removed through one or more outlet ports. Although illustrated as a single port 24, those skilled in the art will realize that, once the emulsion is broken, the hydrocarbon component will tend to separate from the water component with the hydrocarbon component being less dense. Accordingly, often there will be an upper port through which mostly hydrocarbons are removed and a lower port through which mostly water is removed. The effluents from the one or more outlet ports 24 can be introduced to separation systems, as are known in the art, for separating the oil component from the water component.

Additionally, prior to operation, the method may further comprise filling the heat exchanger tube 30 with heat transfer fluid 50 such that electric heating element 42 is in contact with heat transfer fluid 50. As indicated above, during operation, emulsion 90 is heated sufficiently to break the emulsion into its hydrocarbon and water components. Generally, the emulsion is heated to a temperature from about 50° F. to about 160° F. In more typical embodiments, the emulsion may be heated to from 110° F. to 140° F. Additionally, the water component of the emulsion may be fresh water, salt water or brine. Heating emulsion 90 as indicated above using electric heating element 42 and heat transfer fluid 50 typically prevents hot spots, and in turn less cracks and/or holes, within heat exchanger tube 30 as an open flame is not constantly set on the inner surface of heat exchanger tube 30. It also results in an open flame not being introduced into a processing plant around flammable gases and products and less emissions into the environment. This typically reduces the amount of downtime of the processing plant for maintenance and reduces the number of injuries.

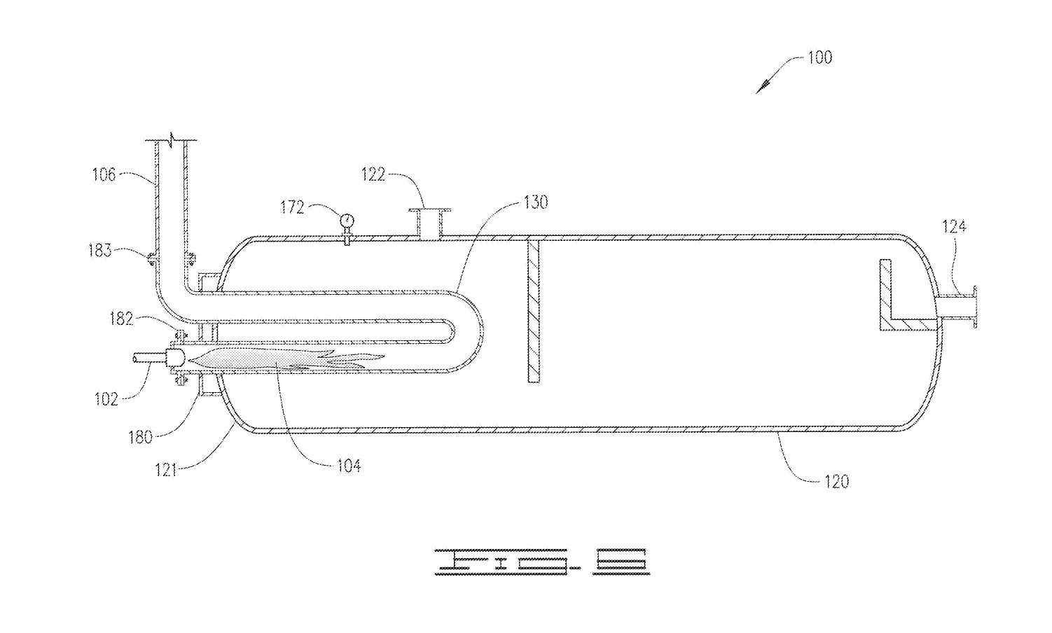

Referring now specifically to FIGS. 6-8, a method of retrofitting a heater will now be described. FIG. 6 illustrates a heater treater 100 having a housing 120, outer surface 121, inlet port 122, and outlet port 124. Heater treater 100 uses a burner 102 and flame 104 as the heating element. Heater treater 100 has at least one heat exchanger tube 130 and burner 102 in communication with heat exchanger tube 130. Heat exchanger tube 130 may further comprise an exhaust stack 106 for flame 104. Heat exchanger tube 130 may be sealed with an end cap 180. The method may comprise removing burner 102 from communication with heat exchanger tube 130. Methods of removing burner 102 include, without limitation, unbolting burner 102 from connection with end cap 180, laser cutting, and flame cutting.

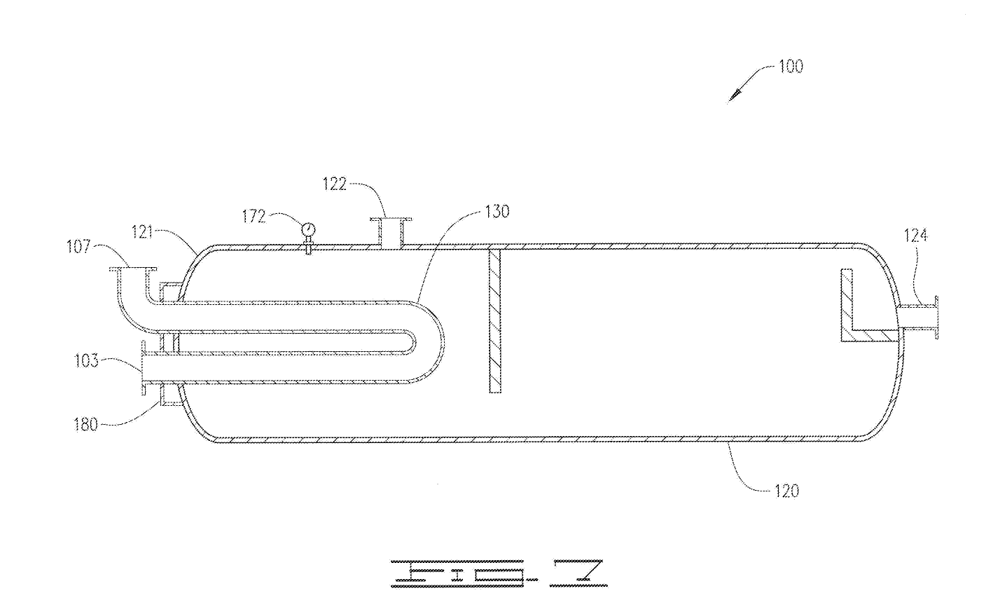

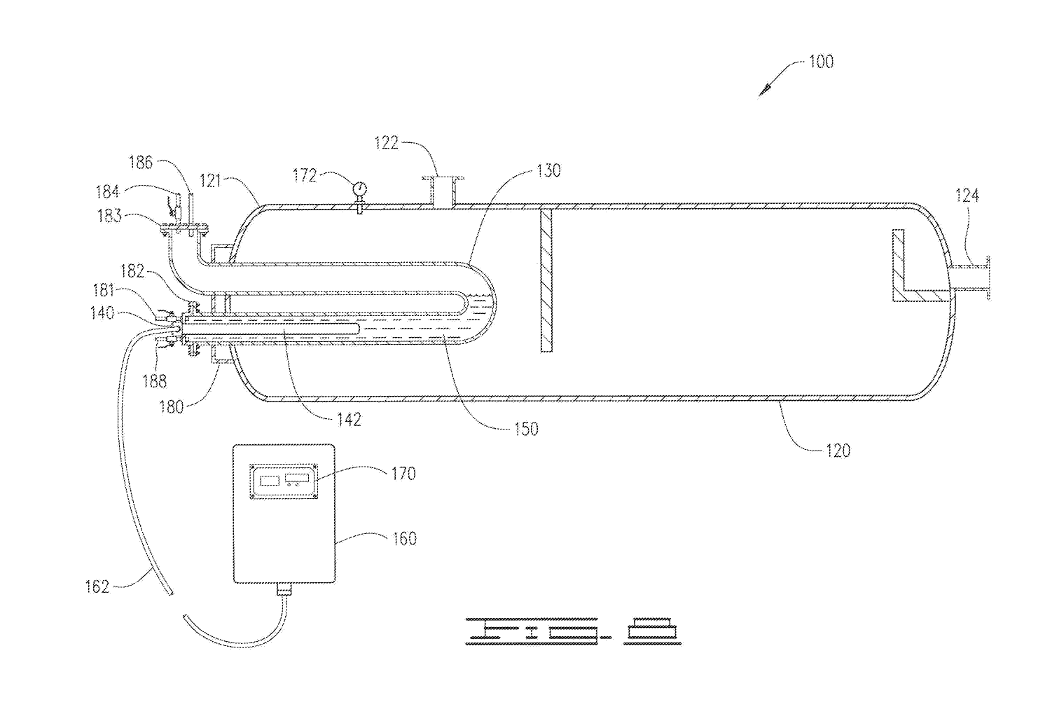

Turning now to FIG. 7, once burner 102 is removed, an opening 103 through end cap 180 and into heat exchanger tube 130 is created. In embodiments including exhaust stack 106, removal of exhaust stack 106 may further be required. Methods of removing exhaust stack 106 include, without limitation, unbolting exhaust stack 106 from connection with end cap 180, laser cutting, and flame cutting. Once exhaust stack 106 is removed, an opening 107 through end cap 180 and into heat exchanger tube 130 is created. In such embodiments including exhaust stack 106, the area where exhaust stack 106 is removed may be sealed with a flange 183, as seen in FIG. 8. Flange 183 may include a pressure relief valve 184 and/or a fill neck 186. Fill neck 186 may be used for filling heat exchanger tube 130 with heat exchanger fluid 150. FIG. 7 illustrates heater treater 100 after removal of burner 102 and exhaust stack 106.

Referring now to FIG. 8, the method may further comprise positioning an electric heater 140 having an electric heating element 142 through opening 103 in end cap 180 such that electric heating element 142 is at least partially within heat exchanger tube 130. Electric heater 140 is connected to end cap 180 with flange 182. In some embodiments, flange 182 may include check valve 181 and drain 188. Drain 188 allows heat transfer fluid 150 to be removed from heat exchanger tube 130. In some embodiments, the method may further comprise sealing opening 107 with flange 181 which may include pressure relief valve 184 and/or fill neck 186.

Heat exchanger tube 130 is then filled with a sufficient volume of heat transfer fluid 150 such that electric heating element 142 is in contact with heat transfer fluid 150. Heat exchanger tube 130 may be filled through fill neck 186 of end cap 180. Fill neck 186 is then sealed using any method known to those of ordinary skill in the art.

In some embodiments, the method may further include hooking up electric heater 140 to a power source 160. Power source 160 is communicated to electric heater 140 via probe line 162. In other embodiments, the method may include hooking up temperature controller 170 which includes temperature probe 172. Temperature controller 170 is put in communication with electric heater 140 and power source 160 via a probe line. Temperature probe 172 may be put in communication with temperature controller 170 wirelessly or via a probe line. Temperature probe 172 is then placed in contact with the interior of housing 120 such that the temperature of an emulsion in housing 120 may be detected. In operation, temperature probe 172 measures the temperature of an emulsion within housing 120. That measurement is then communicated to temperature controller 170 which then communicates with electric heater 140 to increase or decrease the heat output of electric heating element 142 depending on whether the temperature of the emulsion is above or below the desired temperature. In some embodiments, the method may further include flange 182 being equipped with a temperature probe such that the temperature of heat transfer fluid 150 may be monitored and measured.

Therefore, the present disclosure is well adapted to attain the ends and advantages mentioned, as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present disclosure. While apparatus and methods may be described in terms of “comprising,” “containing,” “having,” or “including” various components or steps, the apparatus and methods can also, in some examples, “consist essentially of” or “consist of” the various components and steps. Also, the terms in the claims have their plain, ordinary meaning unless otherwise explicitly and clearly defined by the specification.

What is claimed is:

1. A heater treater comprising:
a housing having one or more fluid inlet and outlet ports;
at least one heat exchanger tube positioned at least partially within the housing so as to be in contact with an emulsion flowing through the housing;
at least one electric heater having an electric heating element positioned within the at least one heat exchanger tube; and
a sufficient volume of a heat transfer fluid within the heat exchanger tube such that the electric heater is in contact with the heat transfer fluid.

2. The heater treater of claim 1, further comprising:
an electrical power source in communication with the electric heater; and
a temperature controller in communication with the electric heater and the electrical power source, the temperature controller including a temperature probe in contact with the emulsion, wherein the temperature controller regulates electrical current from the electrical power source to the electric heater to increase or decrease the heat output of the electric heating element.

3. The heater treater of claim 1, wherein the heater treater comprises two or more heat exchanger tubes positioned within the housing.

4. The heater treater of claim 1, wherein one end of the at least one heat exchanger tube is outside the housing.

5. The heater treater of claim 1, wherein the electric heating element has a length of 50% or less of the length of the heat exchanger tube.

6. The heater treater of claim 1, wherein at least one heat exchanger tube has two electric heating elements positioned within the heat exchanger tube.

7. The heater treater of claim 1, wherein the sufficient volume of the heat transfer fluid is in contact with at least 50% of the inner surface of the at least one heat exchanger tube.

8. The heater treater of claim 1, wherein the heat transfer fluid is glycol.

9. The heater treater of claim 8, wherein the heat transfer fluid is triethylene glycol.

10. The heater treater of claim 1, further comprising a temperature probe immersed in the heat transfer fluid such that the temperature probe can measure the temperature of the heat transfer fluid.

11. The heater treater of claim 1, wherein the heat exchanger tube is a closed system.

12. The heater treater of claim 1, further comprising a fill neck, wherein the heat transfer fluid may be introduced into the heat exchanger tube through the fill neck.

13. The heater treater of claim 1, further comprising a drain, wherein the heat transfer fluid may be removed from the heat exchanger tube through the drain.

14. The heater treater of claim 1 further comprising:
two or more heat exchanger tubes positioned at least partially within the housing;
the electric heating element having a length of 50% or less of the length of the two or more heat exchanger tubes;
the heat transfer fluid being triethylene glycol, wherein the triethylene glycol is in contact with at least 50% of the inner surface of the two or more heat exchanger tubes;
an electrical power source in communication with the electric heater;
a temperature controller in communication with the electric heater and the electrical power source, the temperature controller including a first temperature probe in contact with the emulsion, wherein the temperature controller regulates electrical current from the electrical power source to the electric heater to increase or decrease the heat output of the electric heating element; and
a second temperature probe in contact with the triethylene glycol such that the second temperature probe can measure the temperature of the triethylene glycol.

15. A method of using a heater treater to heat emulsions, the method comprising:
flowing an emulsion through a housing; and
heating the emulsion as it flows through the housing with at least one electric heater having an electric heating element positioned within at least one heat exchanger tube, wherein the at least one heat exchanger tube is at least partially within the housing so as to be in contact with the emulsion.

16. The method of claim 15, further comprising filling the at least one heat exchanger tube with a sufficient volume of a heat transfer fluid such that the electric heating element is in contact with the heat transfer fluid.

17. The method of claim 15, wherein the emulsion is heated with the at least one electric heater having an electric heating element to a temperature between 100° F. and 140° F.

18. The method of claim 15, wherein the emulsion flowing into and out of the housing may be comprised of hydrocarbons and water.

19. The method of claim 15, further comprising:
flowing the heated emulsion into the housing through an inlet port of the housing; and
flowing the heated emulsion out of the housing through an outlet port of the housing.

20. A method of retrofitting a heater treater having at least one heat exchanger tube positioned at least partially within a housing of the heater treater and a burner in communication with the at least one heat exchanger tube, comprising:
removing the burner from communication with the at least one heat exchanger tube;
positioning an electric heater such that an electric heating element of the electric heater is within the at least one heat exchanger tube;
filling the at least one heat exchanger tube with a sufficient volume of a heat transfer fluid such that the electric heating element is in contact with the heat transfer fluid; and
sealing the at least one heat exchanger tube, thereby retaining the heat transfer fluid within the at least one heat exchanger tube.

21. The method of claim 20, further comprising:
removing an upper portion of an exhaust stack; and
sealing the remaining portion of the exhaust stack with a flange, wherein the flange is equipped with a pressure relief valve and a fill neck, the fill neck used for filling the at least one heat exchanger tube with the heat transfer fluid.

22. The method of claim 20, further comprising:
providing a temperature controller in communication with the electric heater and an electrical power source, the temperature controller including a temperature probe in contact with an emulsion within the housing, the temperature controller capable of managing the flow of electricity from the electrical power source to the electric heater, wherein the temperature controller regulates electrical current from the electrical power source to the electric heater to increase or decrease the heat output of the electric heating element.

23. The method of claim 20, wherein the heat transfer fluid is triethylene glycol.
